(19) United States
(12) Patent Application Publication
(10) Pub. No.: US 2008/0284692 A1
(43) Pub. Date: Nov. 20, 2008

(54) METHOD FOR CONTROLLING BACKLIGHT APPARATUS AND LUMINANCE CONTROL CIRCUIT THEREOF

(75) Inventors: Han-Yu Chao, Tainan County (TW); Bi-Hsien Chen, Pingtung County (TW); Shin-Chang Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/060,273

(22) Filed: Apr. 1, 2008

(30) Foreign Application Priority Data
May 14, 2007 (TW) 96117014

(51) Int. Cl. G09G 3/30; G09G 3/36

(52) U.S. Cl. 345/77; 345/690; 345/102

(57) ABSTRACT

A luminance control circuit including a detection unit, a control unit and a current adjustor is provided. The detection unit detects a working current of each light emitting module and produces detection signals to be transmitted to the control unit. The control unit produces control signals according to the detection signals to be transmitted to the current adjustor. The current adjustor adjusts each of the working currents of each of the light emitting modules according to the control signals.

### CROSS-REFERENCE TO RELATED APPLICATION

This application claims the priority benefit of Taiwan application serial no. 96117014, filed on May 14, 2007. The entirety the above-mentioned patent application is hereby incorporated by reference herein and made a part of specification.

### BACKGROUND OF THE INVENTION

1. Field of the Invention

The present invention relates to a backlight apparatus and a luminance control circuit thereof, and more particularly relates to a method for controlling a backlight apparatus and a luminance control circuit thereof.

2. Description of Related Art

A light emitting diode (LED) has advantages of compactness, power consumption, long lifetime, and so forth. Therefore, the LED is extensively applied to various IT devices such as mobile phones, cameras and liquid crystal displays (LCDs).

As regards to the LCD, the LED may be used as a backlight source thereof. As the LCD adopts the LED as the backlight source, a plurality of LEDs is required, such that luminance of display images can satisfy users' requirements. In addition, since the LCD employs a great number of LEDs, driving currents of the LEDs are increased, and the number of driving circuits of the LEDs is raised. Accordingly, when designing the backlight sources for the LEDs, a plurality of light emitting modules is coupled to each other in parallel, and each of the light emitting modules further includes a plurality of the LEDs. Thereby, the driving currents of the LEDs and the number of the driving circuits of the LEDs are reduced.

However, during the fabrication of the LED, a cross voltage thereof may be affected by temperature, crystal properties, or short circuit caused by the LED, and thus different cross voltages may be generated by different LEDs. Accordingly, when a conventional backlight source of the LED is designed, each of the light emitting modules is formed by connecting a plurality of the LEDs in series, such that an error value of the cross voltage in each of the LEDs may be accumulated, resulting in the fact that a total value of the cross voltages in each of the light emitting modules is not identical. In as much as the total value of the cross voltages of the LEDs in each of the light emitting modules is different, the working current then varies on the condition that a constant working voltage is input. The different luminance of each of the light emitting modules then brings about uneven brightness of the display images.

### SUMMARY OF THE INVENTION

Accordingly, the present invention is directed to a backlight apparatus and a luminance control circuit thereof, and a working current of each light emitting module can be adjusted through a current adjustor.

The present invention is further directed to a method for controlling luminance. The method is employed to synchronically control luminance of a plurality of light emitting modules, such that luminance of each of the light emitting modules is identical.

The present invention provides a luminance control circuit adapted to synchronically control luminance of a plurality of light emitting modules. The luminance control circuit includes a detection unit, a control unit and a current adjustor. The detection unit detects a working current of each light emitting module and produces a plurality of detection signals to be transmitted to the control unit. The control unit produces a plurality of control signals according to the plurality of the detection signals. Besides, the current adjustor is disposed between the plurality of the light emitting modules and the detection unit, and the working current of the corresponding light emitting module is adjusted based on the control signals generated by the control unit.

The present invention further provides a backlight apparatus including a plurality of light emitting modules, a detection unit, a control unit, and a current adjustor. The detection unit is used to detect a working current of each of the light emitting modules and to produce corresponding detection signals. The control unit is coupled to the detection unit for receiving the detection signals and producing a plurality of control signals. Besides, the current adjustor is disposed between the plurality of the light emitting modules and the detection unit, and the working current of the corresponding light emitting module is adjusted based on the control signals generated by the control unit.

The present invention further provides a method for controlling luminance. The method is adapted to synchronically control luminance of a plurality of light emitting modules. In the method for controlling luminance according to the present invention, a working current passing through each of the light emitting modules is detected for producing a plurality of detection signals. Thereafter, a plurality of control signals is produced based on the detection signals and each of the working currents of each of the light emitting modules is synchronically adjusted based on each of the control signals.

In the present invention, the backlight apparatus and the luminance control circuit thereof can adjust each of the working currents of each of the light emitting modules to the same amount based on the method of controlling luminance, such that each of the light emitting modules has the same luminance. As such, luminance at each point of the display images is identical.

In order to the make the aforementioned and other objects, features and advantages of the present invention comprehensible, several embodiments accompanied with figures are described in detail below.

### BRIEF DESCRIPTION OF THE DRAWINGS

FIG. 1 illustrates a backlight apparatus according to an embodiment of the present invention.

FIG. 2 illustrates a control unit according to an embodiment of the present invention.

FIG. 3 illustrates a method for controlling luminance according to an embodiment of the present invention.

FIG. 4 illustrates a working current adjusted through performing a method for controlling luminance according to the present invention.

FIG. 5 illustrates the method for controlling luminance according to another embodiment of the present invention.

FIG. 6 illustrates the working current adjusted through performing the method for controlling luminance according to another embodiment of the present invention.

### DESCRIPTION OF EMBODIMENTS

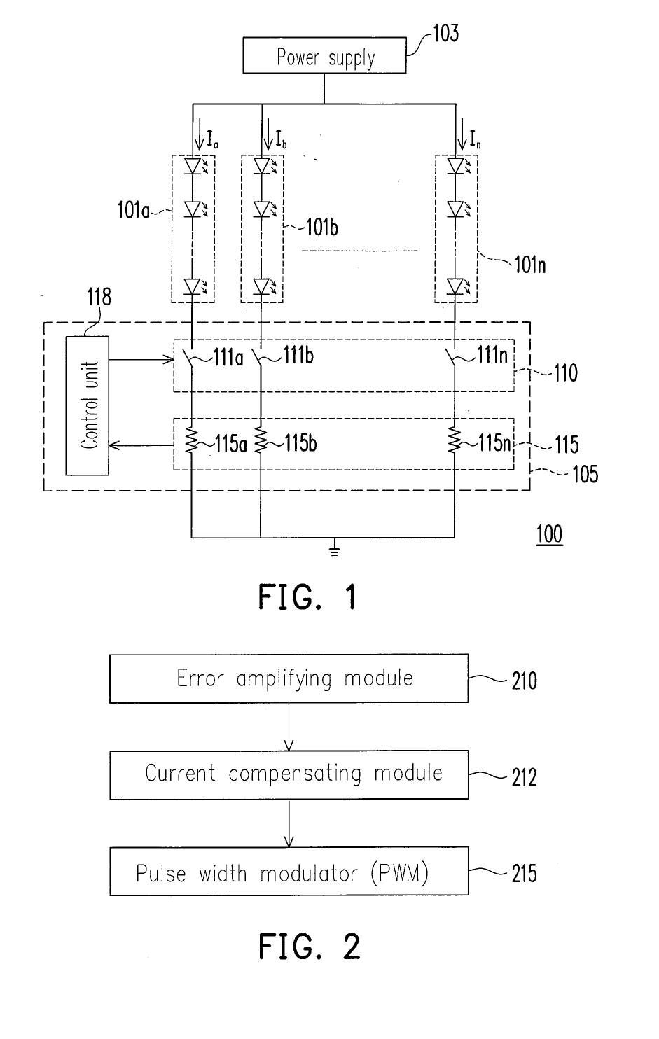

FIG. 1 illustrates a backlight apparatus according to an embodiment of the present invention. Referring to FIG. 1, a backlight apparatus 100 includes a power supply 103, a luminance control circuit 105 and a plurality of light emitting modules 101a˜101n. The power supply 103 provides the power required for operating each of the light emitting modules 101a˜101n, while the luminance control circuit 105 is adapted to synchronically control luminance of the plurality of the light emitting modules 101a˜101n.

The luminance control circuit 105 includes a detection unit 115, a control unit 118 and a current adjustor 110. The detection unit 115 further includes a plurality of resistors 115a˜115n respectively coupled to the corresponding light emitting modules 101a˜101n for detecting each of working currents Ia˜In of each of the light emitting modules 101a˜101n and generating a plurality of detection signals to be transmitted to the control unit 118. Besides, the current adjustor 110 is disposed between the light emitting modules 101a˜101n and the detection unit 115 for receiving control signals generated by the control unit 118 and adjusting each of the working currents Ia˜In of each of the light emitting modules 101a˜101n based on the corresponding control signals.

FIG. 2 illustrates a control unit according to an embodiment of the present invention, and the control unit 118 depicted in FIG. 1 can be embodied thereby. The control unit 118 includes an error amplifying module 210, a current compensating module 212 and a pulse width modulator (PWM) 215. The error amplifying module 210 is coupled to the detection unit 115 for comparing a reference voltage signal with a plurality of the detection signals generated by the detection unit 115, and a plurality of comparison signals is then produced and transmitted to the current compensating module 212.

Here, the current compensating module 212 may generate a plurality of compensating control signals based on the comparison signals and transmit the compensating control signals to the PWM 215. Based on the compensating control signals, the PWM 215 produces a plurality of the control signals to the current adjustor 110 by which each of the working currents Ia˜In of each of the light emitting modules 101a˜101n may be adjusted.

Please refer to FIGS. 1 and 2 together. The current module 101a is not only coupled to the power supply 103 but also coupled to a switch 111a. Besides, the current module 101a is grounded through a resistor 115a. As a constant voltage source is provided by the power supply 103 to the light emitting module 101a and the switch 111a is turned on, the working current Ia passing through the light emitting module 101a, the switch 111a and the resistor 115a is generated. Moreover, in the present embodiment, a plurality of the light emitting modules 101a˜101n may be connected in parallel based on users' requirements, and each of the light emitting modules 101a˜101n is coupled to the corresponding switches 111a˜111n and resistors 115a˜115n. Likewise, as the constant voltage source is provided by the power supply 103 to the light emitting modules 101a˜101n and the switches 111a˜111n are turned on, the corresponding working currents Ia˜In are then generated.

Moreover, the light emitting modules 101a˜101n further include a plurality of LEDs, and a cathode terminal of each of the LEDs is coupled to an anode terminal of a next LED. Due to temperature, crystal properties, or short circuit caused by each of the LEDs, different cross voltages may be generated. Therefore, a total value of the cross voltages of the LEDs in each of the light emitting modules 101a˜101n does not remain unchanged, resulting in different working currents Ia˜In in each of the light emitting modules 101a˜101n.

As the working currents Ia˜In pass through the resistors 115a˜115n, voltage signals are produced in the corresponding resistors 115a˜115n and transmitted to the error amplifying module 210. It should be noted that the working currents Ia˜In passing through the light emitting modules 101a˜101n may be transformed to voltage signals through the resistors 115a˜115n according to the present embodiment.

Besides, with reference to FIG. 2, the error amplifying module 210 further includes a plurality of error amplifiers. In addition to receiving the corresponding voltage signals, the error amplifiers also receive the reference voltage signal and produce the corresponding comparison signals to be transmitted to the current compensating module 212. Thereby, the current compensating module 212 may generate a plurality of the compensating control signals based on the comparison signals, and transmit the same to the PWM 215.

Moreover, the PWM 215 may also generate a plurality of the control signals to be transmitted to the current adjustor 110 based on the compensating control signals. Each of the working currents Ia˜In of each of the light emitting modules 101a˜101n may be adjusted by whether the switches 111a˜111n of the current adjustor 110 are turned on or not, such that each of the light emitting modules 101a˜101n have the same luminance. As such, luminance at each point of the display images is identical.

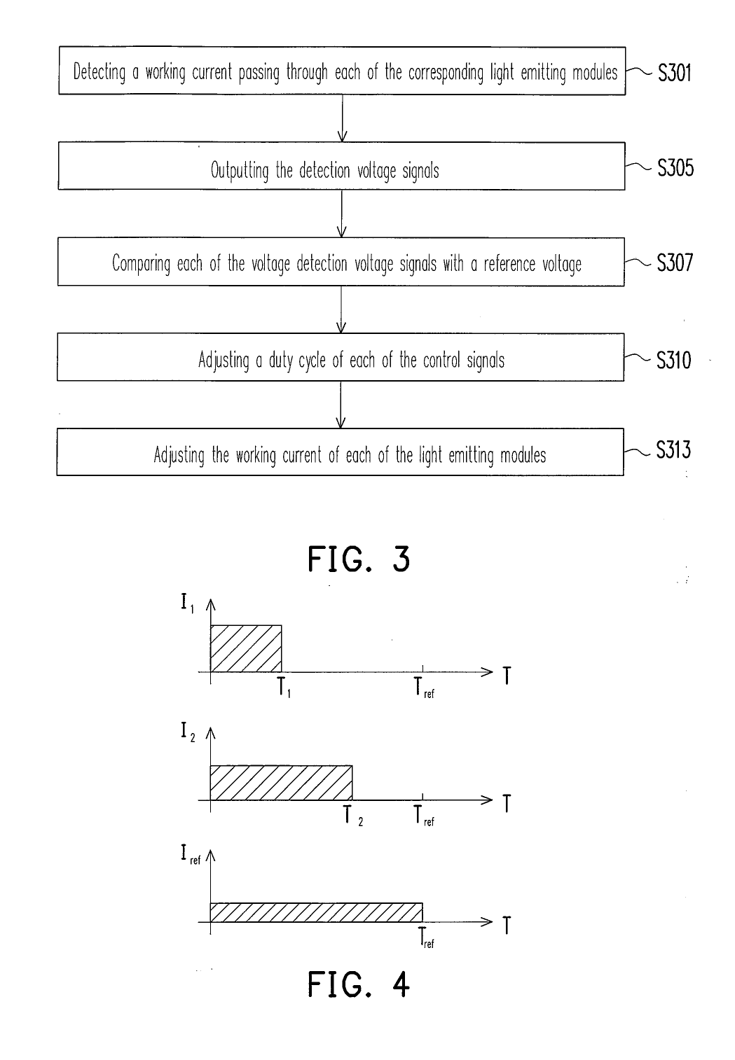

FIG. 3 illustrates a method for controlling luminance according to an embodiment of the present invention. The method is adapted to synchronically control luminance of a plurality of light emitting modules. Referring to FIG. 3, the method for controlling luminance according the present invention includes detecting a working current passing through each of the light emitting modules S301 and transforming detection signals in a form of the working currents to voltage detection signals S305. Further, a plurality of control signals may be generated based on the detection signals.

Thereafter, each of the voltage detection signals is compared with a reference voltage S307, and a plurality of comparison signals is generated. According to the method for controlling luminance in the present invention, a duty cycle of each of the control signals can be adjusted S310 based on each of the comparison signals on the condition that a frequency of the corresponding control signal is predetermined.

When one of the voltage detection signals exceeds the reference voltage, the duty cycle of the corresponding control signal is reduced, so as to decrease the working current of each of the corresponding light emitting modules S313. On the contrary, when one of the voltage detection signals is less than the reference voltage, the duty cycle of the corresponding control signal is increased, so as to increase the working current of the corresponding light emitting module S313. Thereby, each of the working currents of each of the light emitting modules is adjusted to the same amount, and thus luminance at each point of the display images is identical.

FIG. 4 illustrates a working current adjusted through performing a method for controlling luminance according to the present invention. Please refer to FIG. 4 in which a reference current Iref and the working currents I1 and I2 respectively passing through two light emitting modules are depicted. The duty cycles of the reference current Iref and the working currents I1 and I2 are Tref, T1 and T2, respectively. As the voltage detection signals are proportional to the corresponding currents, and the working current I1>the working current I2>the reference current Iref, the voltage detection signal generated by the working current I1 has the greatest value. The value of the voltage detection signal generated by the working current I2 is relatively small, and the voltage detection signal generated by the reference current Iref has the smallest value. Furthermore, according to the method for controlling luminance in the present invention, the duty cycles of the corresponding control signals should be reduced when the voltage detection signals exceed the reference voltage, so as to reduce the working currents of the corresponding light emitting modules. Hence, the greater the voltage detection signals are, the smaller the duty cycles of the control signals are. As such, the duty cycle Tref of the reference current Iref occupies the largest value followed by the duty cycle T2 of the working current I2 and the duty cycle T1 of the working current I1.

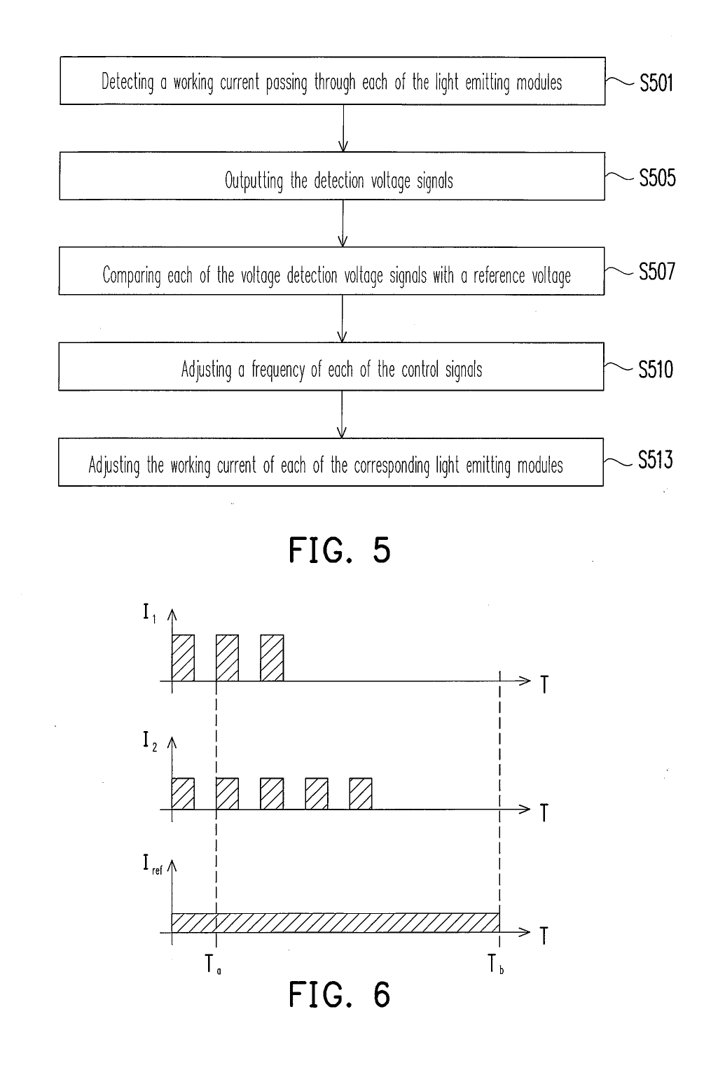

FIG. 5 illustrates the method for controlling luminance according to another embodiment of the present invention. The method is adapted to synchronically control luminance of a plurality of light emitting modules. Referring to FIG. 5, the method for controlling luminance according the present invention includes detecting each working current passing through each of the light emitting modules S501 and transforming detection signals in a form of the working currents to voltage detection signals S505. Further, a plurality of control signals may be generated based on the detection signals.

Thereafter, each of the voltage detection signals is compared with a reference voltage S507, and a plurality of comparison signals is generated. According to the method for controlling luminance in the present invention, a frequency of each of the control signals can be adjusted based on each of the comparison signals on the condition that the duty cycle of each of the corresponding control signals is predetermined.

When one of the voltage detection signals exceeds the reference voltage, the frequency of the corresponding control signal is reduced, so as to decrease the working current of the corresponding light emitting module S513. On the contrary, when one of the voltage detection signals is less than the reference voltage, the frequency of the corresponding control signal is increased S510, so as to increase the working current of the corresponding light emitting module S513. Thereby, each of the working currents of each of the light emitting modules is adjusted to the same amount, and thus luminance at each point of the display images is identical.

FIG. 6 illustrates the working current adjusted through performing the method for controlling luminance according to another embodiment of the present invention. Please refer to FIG. 6 in which a reference current Iref and working currents I1 and I2 respectively passing through two light emitting modules are depicted. The working currents I1 and I2 share the same duty cycles. As the voltage detection signals are proportional to the corresponding currents, and the working current I1>the working current I2>the reference current Iref, the voltage detection signal generated by the working current I1 has the greatest value. The value of the voltage detection signal generated by the working current I2 is relatively small, and the voltage detection signal generated by the reference current Iref has the smallest value. Furthermore, according to the method for controlling luminance in the present invention, the frequencies of the corresponding control signals should be reduced when the voltage detection signals exceed the reference voltage, so as to reduce the working currents of the corresponding light emitting modules. Hence, the greater the voltage detection signals are, the smaller the frequencies of the control signals are. As such, during a time frame Ta˜Tb, the frequency generated by the working current I2 exceeds that generated by the working current I1.

In light of the foregoing, the backlight apparatus provided in the present invention includes the power supply, the luminance control circuit and a plurality of the light emitting modules. Here, the luminance control circuit is adapted to synchronically control luminance of a plurality of the light emitting modules and to provide the same working current to each of the light emitting modules, such that luminance at each point of the display images is identical.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A luminance control circuit for synchronically controlling luminance of a plurality of light emitting modules, the luminance control circuit comprising:
a detection unit, for detecting a working current of each of the light emitting modules and producing a plurality of detection signals;
a control unit, coupled to the detection unit and used to produce a plurality of control signals based on the detection signals; and
a current adjustor, disposed between the light emitting modules and the detection unit for adjusting each of the working currents of each of the light emitting modules based on the control signals.

2. The luminance control circuit as claimed in claim 1, wherein the detection unit comprises a plurality of resistors coupled to the light emitting modules respectively, and each of the working currents of each of the light emitting modules are transformed to voltage detection signals, so as to transmit the detection signals to the control unit.

3. The luminance control circuit as claimed in claim 1, each of the light emitting modules comprising a plurality of light emitting diodes (LEDs), wherein each of the LEDs has a cathode terminal coupled to an anode terminal of a next LED, and the cathode terminal of the last LED is grounded through the corresponding resistor in the detection unit.

4. The luminance control circuit as claimed in claim 1, wherein the control unit comprises:
an error amplifying module, coupled to the detection unit for comparing the detection signals with a reference voltage signal and producing a plurality of comparison signals;
a current compensating module, coupled to the error amplifying module for producing a plurality of compensating control signals based on the comparison signals; and
a pulse width modulator (PWM), coupled to the current compensating module for producing the control signals for the current adjustor based on the comparison signals.

5. The luminance control circuit as claimed in claim 4, wherein the error amplifying module comprises a plurality of error amplifiers receiving the detection signals and the reference voltage signal and outputting the corresponding comparison signals respectively.

6. The luminance control circuit as claimed in claim 1, wherein the current adjustor comprises a plurality of switches disposed between the light emitting modules and the detection unit, and whether each of the switches is conducted or not is determined upon one of the control signals.

7. A backlight apparatus, comprising:
a plurality of light emitting modules;
a detection unit, for detecting a working current of each of the light emitting modules and producing a plurality of detection signals;
a control unit, coupled to the detection unit for producing a plurality of control signals based on the detection signals; and
a current adjustor disposed between the light emitting modules and the detection unit for adjusting each of the working currents of each of the light emitting modules based on the control signals.

8. The backlight apparatus as claimed in claim 7, wherein the detection unit comprises a plurality of resistors coupled to the light emitting modules respectively, and each of the working currents passing through each of the light emitting modules are transformed to voltage detection signals, so as to transmit the detection signals to the control unit.

9. The backlight apparatus as claimed in claim 8, each of the light emitting modules comprising a plurality of LEDs, wherein each of the LEDs has a cathode terminal coupled to an anode terminal of a next LED, and the cathode terminal of the last LED is grounded through the corresponding resistor in the detection unit.

10. The backlight apparatus as claimed in claim 7, wherein the control unit comprises:
an error amplifying module, coupled to the detection unit for comparing the detection signals with a reference voltage signal and producing a plurality of comparison signals;
a current compensating module, coupled to the error amplifying module for producing a plurality of compensating control signals based on the comparison signals; and
a PWM, coupled to the current compensating module for producing the control signals for the current adjustor based on the compensating control signals.

11. The backlight apparatus as claimed in claim 10, wherein the error amplifying module comprises a plurality of error amplifiers receiving the detection signals and the reference voltage signal and outputting the corresponding comparison signals respectively.

12. The backlight apparatus as claimed in claim 7, wherein the current adjustor comprises a plurality of switches disposed between the light emitting modules and the detection unit, and whether each of the switches is conducted or not is determined upon one of the control signals.

13. The backlight apparatus as claimed in claim 7, further comprising a power supply for providing the power required for operating each of the light emitting modules.

14. A method for synchronically controlling luminance of a plurality of light emitting modules, the method comprising:
detecting each working current passing through each of the light emitting modules for producing a plurality of detection signals; and
producing a plurality of control signals based on the detection signals for synchronically adjusting each of the working currents of each of the light emitting modules.

15. The method for controlling luminance as claimed in claim 14, further comprising transforming each of the working currents passing through each of the light emitting modules to a voltage detection signal.

16. The method for controlling luminance as claimed in claim 14, wherein the step of adjusting each of the working currents of each of the light emitting modules based on each of the control signals comprises:
comparing each of the detection signals with a reference voltage signal, so as to produce a plurality of comparison signals; and
adjusting a duty cycle of each of the control signals based on the comparison signals on the condition that a frequency of the control signal is predetermined, so as to correspondingly control each of the working currents of each of the light emitting modules.

17. The method for controlling luminance as claimed in claim 16, wherein the step of adjusting each of the working currents of each of the light emitting modules further comprises reducing each of the duty cycles of the corresponding control signals when one of the detection signals exceeds the reference voltage, so as to reduce the working current of the corresponding light emitting module.

18. The method for controlling luminance as claimed in claim 16, wherein the step of adjusting each of the working currents of each of the light emitting modules further comprises increasing each of the duty cycles of each of the corresponding control signals when one of the detection signals is less than the reference voltage, so as to increase the working current of the corresponding light emitting module.

19. The method for controlling luminance as claimed in claim 14, wherein the step of adjusting each of the working currents of each of the light emitting modules based on each of the control signals comprises:
comparing each of the detection signals with a reference voltage signal, so as to produce a plurality of comparison signals; and
adjusting a frequency of each of the control signals based on the comparison signals on the condition that a duty cycle of each of the control signals is predetermined, so as to correspondingly control each of the working currents of each of the light emitting modules.

20. The method for controlling luminance as claimed in claim 19, wherein the step of adjusting each of the working currents of each of the light emitting modules further comprises reducing the frequency of each of the corresponding control signals when one of the detection signals exceeds the reference voltage, so as to reduce the working current of the corresponding light emitting module.

21. The method for controlling luminance as claimed in claim 19, wherein the step of adjusting each of the working currents of each of the light emitting modules further comprises increasing the frequency of each of the corresponding control signals when one of the detection signals is less than the reference voltage, so as to increase the working current of the corresponding light emitting module.
